(19) United States
(12) Patent Application Publication
(10) Pub. No.: US 2025/0048491 A1
(43) Pub. Date: Feb. 6, 2025

(54) DATA TRANSMISSION METHOD AND APPARATUS, COMPUTER-READABLE MEDIUM, AND ELECTRONIC DEVICE

(71) Applicant: TENCENT TECHNOLOGY (SHENZHEN) COMPANY LIMITED, Shenzhen (CN)

(72) Inventor: Yixue LEI, Shenzhen (CN)

(73) Assignee: TENCENT TECHNOLOGY (SHENZHEN) COMPANY LIMITED, Shenzhen (CN)

(21) Appl. No.: 18/926,594

(22) Filed: Oct. 25, 2024

Related U.S. Application Data
(63) Continuation of application No. PCT/CN2023/110452, filed on Aug. 1, 2023.

(30) Foreign Application Priority Data
Sep. 30, 2022 (CN) 202211230444.5

(51) Int. Cl. H04W 76/28; H04W 72/12

(52) U.S. Cl. CPC H04W 76/28; H04W 72/12

(57) ABSTRACT

A data transmission method includes: receiving network status information on a radio access network side reported by an access network element; receiving a first network transmission characteristic between the access network element and a core network gateway sent by a core network element; detecting a second network transmission characteristic between an application server and the core network gateway; and adjusting a parameter of a first service data packet to be transmitted based on the network status information, the first network transmission characteristic, and the second network transmission characteristic.

### CROSS-REFERENCE TO RELATED APPLICATIONS

This application is a continuation application of International Application No. PCT/CN2023/110452 filed on Aug. 1, 2023, which claims priority to Chinese Patent Application No. 202211230444.5 filed with the China National Intellectual Property Administration on Sep. 30, 2022, the disclosures of each being incorporated by reference herein in their entireties.

### FIELD

The disclosure relates to the field of computer and communication technologies, and in particular, to a data transmission method and apparatus, a computer-readable medium, and an electronic device.

### BACKGROUND

In 5G and evolved 5G systems, high-bandwidth interactive services are important types of services, such as cloud gaming, virtual reality (VR), augmented reality (AR), mixed reality (MR), extended reality (XR), and cinematic reality (CR).

Data packets of such interactive services may have cycles when being transmitted. Taking advantage of the cycles, a wireless network may improve time-frequency resource usage efficiency by adopting a semi-persistent scheduling (SPS) or connected-discontinuous reception (C-DRX) mechanism. However, such mechanisms may not be able to satisfy a quality of service (QoS) condition.

### SUMMARY

Provided are a data transmission method and apparatus, a computer-readable medium, and an electronic device.

According to some embodiments, a data transmission method includes: receiving network status information on a radio access network side reported by an access network element; receiving a first network transmission characteristic between the access network element and a core network gateway sent by a core network element; detecting a second network transmission characteristic between an application server and the core network gateway; and adjusting a parameter of a first service data packet to be transmitted based on the network status information, the first network transmission characteristic, and the second network transmission characteristic

According to some embodiments, a data transmission apparatus includes: at least one memory configured to store computer program code; at least one processor configured to read the program code and operate as instructed by the program code, the program code including: first receiving code configured to cause at least one of the at least one processor to receive network status information on a radio access network side reported by an access network element; second receiving code configured to cause at least one of the at least one processor to receive a first network transmission characteristic between the access network element and a core network gateway sent by a core network element; detection code configured to cause at least one of the at least one processor to detect a second network transmission characteristic between an application server and the core network gateway; and adjustment code configured to cause at least one of the at least one processor to adjust a parameter of a first service data packet to be transmitted based on the network status information, the first network transmission characteristic, and the second network transmission characteristic.

According to some embodiments, a non-transitory computer-readable medium, storing computer code which, when executed by at least one processor, may cause the at least one processor to at least: receive network status information on a radio access network side reported by an access network element, and receive a first network transmission characteristic between the access network element and a core network gateway sent by a core network element; detect a second network transmission characteristic between an application server and the core network gateway; and adjust a parameter of a first service data packet to be transmitted based on the network status information, the first network transmission characteristic, and the second network transmission characteristic.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture according to some embodiments.

FIG. 2 is a schematic diagram of a transmission process of a multimedia data packet according to some embodiments.

FIG. 3 is a schematic diagram of a system architecture of a data transmission method according to some embodiments.

FIG. 4 is a schematic diagram of a comparison between delay jitter distributions in a transmission process of a service data packet according to some embodiments.

FIG. 5 is a flowchart of a data transmission method according to some embodiments.

FIG. 6 is a flowchart of a data transmission method according to some embodiments.

FIG. 7 is a flowchart of a data transmission method according to some embodiments.

FIG. 8 is an interaction flowchart of a data transmission method according to some embodiments.

FIG. 9 is a block diagram of a data transmission apparatus according to some embodiments.

FIG. 10 is a schematic structural diagram of a computer system adapted to implement an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The block diagrams shown in the accompanying drawings are functional entities and do not necessarily correspond to physically independent entities. The functional entities may be implemented in the form of software, or implemented in one or more hardware modules or integrated circuits, or implemented in different networks and/or processor apparatuses and/or micro-controller apparatuses.

The flowcharts shown in the accompanying drawings are examples for descriptions, and are not necessarily performed in the described orders. For example, some operations may be further divided, and some operations may be combined or partially combined. An execution order may change according to an actual case.

“Plurality of” means two or more. And/or describes an association relationship for describing associated objects and represents that three relationships may exist. For example, A and/or B may represent the following three cases: Only A exists, both A and B exist, and only B exists. The character “/” may represent an “or” relationship between the associated objects.

With the development of a 5G-generation mobile communication technology (5G), many multimedia services that use large amounts of data and short delays are applied, for example, interactive services such as a cloud gaming service, VR, AR, MR, XR, and CR.

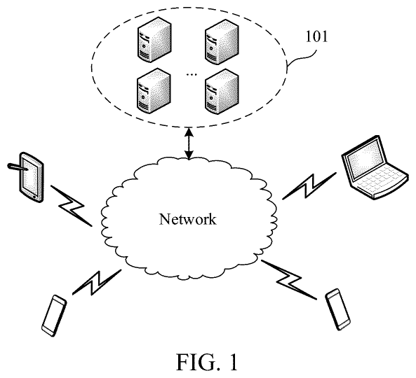

For example, in a cloud gaming scenario shown in FIG. 1, a cloud server 101 may be configured to run cloud gaming. The cloud server 101 may render a game picture, perform encoding processing on an audio signal and a rendered image, and finally transmit encoded data obtained through the encoding processing to each game client through a network. The game client may be user equipment, for example, a smartphone, a tablet computer, a notebook computer, a desktop computer, a smart television, a smart home, an in-vehicle terminal, or an aircraft, with a streaming media playback capability, a human-computer interaction capability, a communication capability, and the like. The game client may be an application running in a terminal device. The game client may decode the encoded data transmitted by the cloud server 101 to obtain a simulated audio and video signal, and play the simulated audio and video signal.

FIG. 1 is only an exemplary system architecture representing a cloud gaming system and does not limit an architecture of the cloud gaming system. For example, in some embodiments, the cloud gaming system may further include a back-end server for scheduling and the like. The cloud server 101 may be an independent physical server, or may be a server cluster or a distributed system formed by a plurality of physical servers, or may be a cloud server that provides a cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The game client and the cloud server 101 may be directly or indirectly connected in a wired or wireless communication manner. The disclosure is not limited thereto.

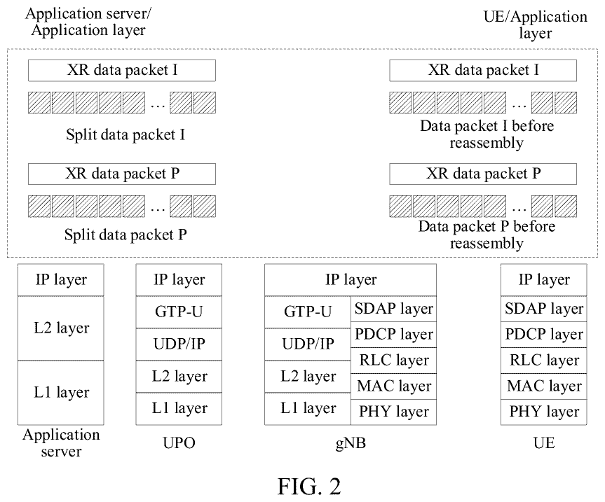

In the interactive service application scenario based on multimedia, because a multimedia data packet may be large, the multimedia data packet may be split into a plurality of data packets for transmission. As shown in FIG. 2, in a 5G system, a user plane may include an application server, a user plane object (UPO) (sometimes referred to as a “user plane function” (UPF) by the 3rd Generation Partnership Project (3GPP), for example), a base station (next generation nodeB, gNB for short), and user equipment (UE). The transmission of the multimedia data packet is in a downlink direction for some service scenarios, for example, from the application server to the UPO, and the multimedia data packet may be sent to the UE through the gNB. During transmission, the multimedia data packet (where an XR data packet is used as an example in FIG. 2) is split at an application layer of the application server. Based on the split data packet reaching the UPO from the application server as an IP packet, the 5G system may transmit the sub-data packets to the UE through a protocol data session (or “protocol data unit” (PDU) session). At the UE, the sub-data packets may be submitted step-by-step upward from a protocol stack and reassembled to recover the multimedia data packet.

In the system shown in FIG. 2, an L1 layer refers to a physical layer, which may ensure original data may be transmitted on various physical media. An L2 layer refers to a data link layer, which may be configured for providing a service to a network layer based on a service provided by the physical layer. An Internet protocol (IP) layer is a network layer and may be configured for implementing data transmission between two terminal systems. UDP is a user data protocol. GTP-U is a general packet radio service (GPRS) tunneling protocol-U. PHY is an abbreviation of Physical, which represents a physical layer. MAC is a Media Access Control (MAC). RLC is a radio link control (radio link control layer protocol). PDCP is a packet data convergence protocol. SDAP is a service data adaptation protocol.

For a multimedia service, such as an XR and Media Services (XRM) service, one frame of multimedia data packet may be divided into a plurality of data packets for transmission. A data packet formed by a single multimedia service frame or a group of packets (GoP) may also be large in bytes and may be carried by a series of Internet protocol (IP) data packets. There may be a correlation between these IP data packets, and processing these packets based on the correlation may save a wireless network bandwidth. Some XRM service flows are cyclical, for example, may be 60/90/120 frame per second (FPS) data packets. A generated video frame may generate data packets at a time interval of approximately 16.67 ms/11.11 ms/8.33 ms time intervals. The wireless network may improve time-frequency resource efficiency by using these cyclical characteristics. For example, based on cyclicity of the XRM service, a semi-persistent scheduling (SPS) or connected-discontinuous reception (C-DRX) mechanism is adopted. However, the premise for using this method is that the 5G system has learned that the XRM service flow is cyclical.

In some embodiments, C-DRX is a connected-discontinuous reception mode. The UE may be allowed to cyclically enter a sleep state without detecting a physical downlink control channel (PDCCH). Based on detection to be used, the UE may wake up from the sleep state and power may be saved.

In some embodiments, an application object (AO) (sometimes referred to as an “application function” (AF) by the 3GPP, for example)/application server (AS) may directly provide cycle information and a delay jitter distribution characteristic of the service flow to a 5G system (5GS). Based on the data packet reaching the base station for wireless network scheduling transmission, the base station may configure C-DRX based on the cyclicity and the delay jitter distribution characteristic of the data packet. However, the base station may not be able to directly learn whether and how a configured C-DRX parameter may satisfy the QoS condition of the application layer. If the AO/AS may not adjust a service flow characteristic of the application layer in time, there may be a situation where the QoS may not be ensured even if the C-DRX configuration is adjusted on the wireless side. For example, the AO/AS has data reaching during C-DRX off (Opportunity for DRX, for example, a sleep period), so that the AO/AS goes from C-DRX off to C-DRX on (On Duration, for example, an activation state) in advance, which causes the C-DRX to fail. Even if the C-DRX off time is not reduced, data other than cyclicity may be delayed or increased due to the DRX configuration, which also affects implementation of application layer QoS guarantee.

In some embodiments, a radio access network (RAN) side (including the gNB and/or the UE) may report a network status parameter of the radio access network side to the AO/AS. A core network side may associate network transmission characteristics per-UE and send the associated network transmission characteristics to the AO/AS. In addition, the AO/AS may measure and predict a link characteristic between the AO/AS and the UPO, so that an end-to-end network transmission characteristic from the AO to the UE is grasped. Parameters that affect the rate such as the frame rate and the resolution of the service data packet may be adjusted to implement flexible adaptation of the service data packet and the network status, which may optimize the QoS.

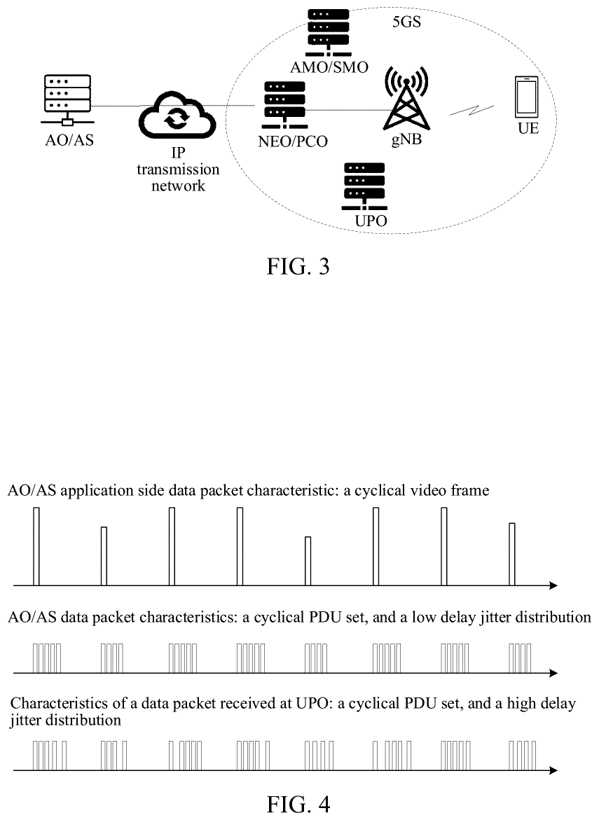

As shown in FIG. 3, the AO/AS may implement a control plane function of a third-party application server and interact through an AO-network exposure object (AO-NEO) (sometimes referred to as an “AO-network exposure function” (AO-NEF) by the 3GPP, for example) or an AO-policy control object (AO-PCF) (sometimes referred to as an “AO-policy control function” (AO-PCF) by the 3GPP, for example). The AO/AS may also implement a user plane object of the third-party application server, for example, through an AS-IP transmission network-UPO interface. In the system architecture shown in FIG. 3, a 5GS gateway may include a UPO, or may include an entity, for example, a network exposure object (NEO) (sometimes referred to as a “network exposure function” (NEF) by the 3GPP, for example), a policy control object (PCO) (sometimes referred to as a “policy control function” (PCF) by the 3GPP, for example), an access and mobility management object (AMO) (sometimes referred to as an “access and mobility management function” (AMF) by the 3GPP, for example), a session management object (SMO) (sometimes referred to as a “session management function” (SMF) by the 3GPP, for example), or a router/switch node deployed between the 5GS and an external network, responsible for capability exposure on a control plane.

In some embodiments, an IP transmission network may be implemented in a wired manner or a wireless manner. For example, the IP transmission network may be a metropolitan area network, an access network, or a wide area network based on an optical network, which depends on a topological relationship between a 5G core network (5GC) boundary and the third-party application server. Because the 5G network adopts a network architecture that may be conducive to UPO sinking, if the AO/AS is located at an edge and the UPO also sinks to the edge, a topological distance between the 5GC boundary (for example, the UPO at the edge) and the AO/AS may be shortened. The AO/AS may be located in a central cloud. UPO sinking may not resolve this problem. An impact of the IP transmission network between the third-party server and a 5GC boundary (for example, a UPO) on service flow transmission may not be ignored.

As shown in FIG. 4, an AO/AS application side data packet characteristic may be, for example, a cyclical video frame. The cyclical video frame is split into a plurality of IP data packets for transmission. The plurality of IP data packets may form a PDU set. A delay jitter distribution of the IP data packet may be smaller. Because these IP data packets may be transmitted between a third-party server AS and a 5GS gateway, based on the IP data packets reaching the UPO, the delay jitter distribution of these IP data packets may become larger. As shown in FIG. 4, a delay between IP data packets within a PDU set becomes larger, resulting in a longer reception time for a PDU set. In some embodiments, the AO/AS may measure and predict a link characteristic between the AO/AS and the UPO, to grasp an end-to-end network transmission characteristic from the AO to the UE.

In addition, the AO/AS, as a third-party application provider, is also a generation (downstream multimedia data in a case of cloud rendering) or forwarding node of a data packet of a multimedia service such as XR. The AO/AS may adjust parameters such as resolution and a frame rate of a data packet of a multimedia service such as XR based on the end-to-end network transmission characteristic from the AO to the UE, so that transmission of the service data packet at the application layer may match the end-to-end network transmission situation, which may improve QoS and may satisfy the QoS condition.

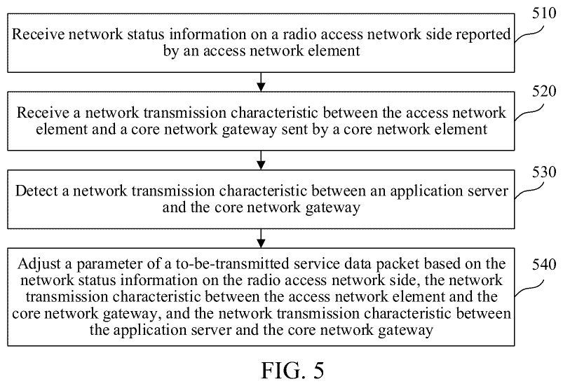

FIG. 5 is a flowchart of a data transmission method according to some embodiments. The data transmission method may be performed by an application layer network element, and for example, may be performed by an AO. Referring to FIG. 5, the data transmission method may include 510 to 540.

Operation 510: Receive network status information on a radio access network side reported by an access network element.

In some embodiments, the network status information on the radio access network side reported by the access network element may include network status information reported by a base station and network status information reported by UE.

The network status information on the radio access network side includes at least one of the following: a scheduling transmission policy adopted for a cyclical service data packet, an application layer service condition of user equipment, or a network status in a serving cell in which the user equipment is located.

In some embodiments, the scheduling transmission policy adopted for the cyclical service data packet may include a C-DRX configuration parameter or an SPS configuration parameter. The C-DRX configuration parameter includes at least one of the following: a C-DRX cycle or activation duration (for example, On Duration duration) and sleep duration (for example, Opportunity for DRX duration) included in a single C-DRX cycle.

In some embodiments, the application layer service condition of the user equipment includes at least one of the following: information about an application running on the user equipment that may be sensed by an application server (for example, the AO and/or the AS), or information about an application running on the user equipment that may not be sensed by the application server. Although these applications may not be sensed by the application server side, if these applications generate traffic, effectiveness of the C-DRX configuration may be affected. Information about the application that may not be sensed by the application server side may also be reported to the application layer, so that the application layer may perform rate adjustment and adaptation for all applications on the UE, may ensure the effectiveness of the C-DRX configuration, and may satisfy the QoS condition.

In some embodiments, the network status of the serving cell in which the user equipment is located includes at least one of the following: a radio link status in the serving cell, occupation of a time-frequency resource in the serving cell, or load information of the serving cell.

The radio link status in the serving cell may be measured by parameters such as a signal to interference plus noise ratio (SINR), reference signal receiving power (RSRP), a reference signal receiving quality (RSRQ), and a received signal strength indication (RSSI). The occupation of the time-frequency resource in the serving cell may be configured for indicating a resource congestion state of the serving cell.

The load information of the serving cell may be measured based on all physical resource blocks (PRBs) of the serving cell and a number of the remaining available PRBs. For example, if a proportion of the remaining available PRBs is relatively low (for example, less than ⅓), it represents that the load of the serving cell is relatively high. Reversely, if the proportion of the remaining available PRBs is relatively high (for example, greater than ⅔), it represents that the load of the serving cell is relatively low.

Operation 520: Receive a network transmission characteristic between the access network element and a core network gateway sent by a core network element.

In some embodiments, the network transmission characteristic between the access network element and the core network gateway sent by the core network element may be determined for each user equipment, for example, Per-UE. The core network element may determine a network transmission characteristic between a base station device and a user plane object for each user equipment based on a transmission link between the base station device and the user plane object, a transmission link between a plurality of user plane objects for data forwarding, and a protocol data session (or “protocol data unit” (PDU) session) and a quality of service flow established for each user equipment.

The access network element may be the base station, and the core network gateway may be the UPO. According to an architecture of the 5G system, based on a service data packet generated by the AS being sent, the service data packet generated by the AS may be transmitted to an access network through UPO-gNB, or may be transmitted to an access network through protocol data session anchor (PSA) UPO-Initial-UPO (I-UPO)-gNB. An interface between the UPO and the gNB is an N3 interface, and an interface between the UPO and the UPO is an N9 interface.

The core network element may determine the network transmission characteristic between the base station device and the user plane object for each user equipment based on a transmission link (for example, an N3 interface link) between the gNB and the UPO, the transmission link (for example, an N9 interface link) between a plurality of user plane objects for data forwarding, and a protocol data session and a quality of service flow (for example, a QoS flow) established for each user equipment.

Still referring to FIG. 5. Operation 530: Detect a network transmission characteristic between an application server and the core network gateway.

The core network gateway is a border device of a core network, for example, may be the UPO, and may be configured for acting as an entry point or an exit point.

In some embodiments, a process of detecting the network transmission characteristic between the application server and the core network gateway may be that: dynamically detect the transmission link between the application server and the core network gateway. Based on a dynamic detection result of the transmission link, a transmission bandwidth and a delay change of the transmission link are determined. The transmission bandwidth and the delay change are the network transmission characteristic between the application server and the core network gateway.

In some embodiments, a process of detecting the network transmission characteristic between the application server and the core network gateway may be that: determine the network transmission characteristic between the application server and the core network gateway based on a service level agreement (SLA) between the application server and the core network. Some embodiments enable that based on the transmission link between the AO/AS and the core network having an SLA protocol, the network transmission characteristic between the application server and the core network gateway may be determined based on the SLA protocol.

In some embodiments, before the network transmission characteristic between the application server and the core network gateway is determined based on the service level agreement SLA between the application server and the core network, whether the SLA has an impact on the delay jitter distribution characteristic of the service data packet may be further evaluated first based on the SLA between the application server and the core network. If the SLA has an impact on the delay jitter distribution characteristic of the service data packet, the network transmission characteristic between the application server and the core network gateway is determined based on the service level agreement SLA between the application server and the core network. If the SLA has no impact on the delay jitter distribution characteristic of the service data packet, the transmission link between the application server and the core network gateway may be dynamically detected, and the network transmission characteristic between the application server and the core network gateway may be determined based on the dynamic detection result of the transmission link.

In some embodiments, a process of detecting the network transmission characteristic between the application server and the core network gateway may be that: According to the service level agreement (SLA) between the application server and the core network, the transmission link between the application server and the core network gateway is dynamically detected to obtain the transmission bandwidth and the delay change of the transmission link. In some embodiments, although the SLA stipulates a service level between the application server and the core network, an actual network status may be used. The SLA may be used as a reference to implement more targeted network transmission characteristic detection based on the SLA to improve accuracy of network transmission characteristic detection.

In some embodiments, the network transmission characteristic between the application server and the core network gateway may include: an impact of the transmission link between the application server and the core network gateway on cycle information and a delay jitter distribution characteristic of the transmitted service data packet.

Operation 540: Adjust a parameter of a to-be-transmitted service data packet based on the network status information on the radio access network side, the network transmission characteristic between the access network element and the core network gateway, and the network transmission characteristic between the application server and the core network gateway.

In some embodiments, the parameter of the to-be-transmitted service data packet includes at least one of the following: a frame rate of the service data packet, resolution of the service data packet, or a cycle of the service data packet.

Adjusting the parameter of the to-be-transmitted service data packet may be that: adjust the cycle of the to-be-transmitted service data packet to an integer multiple of a C-DRX cycle to ensure that the cycle of the service data packet matches the C-DRX cycle, and may ensure the effectiveness of the C-DRX.

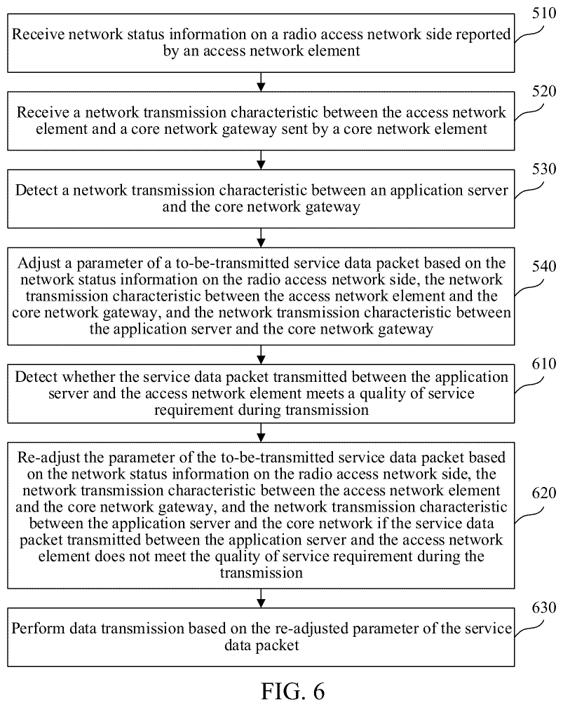

FIG. 6 is a flowchart of a data transmission method according to some embodiments. Based on 510 to 540 shown in FIG. 5, the data transmission method may further include the following operations.

610: Detect whether the service data packet transmitted between the application server and the access network element satisfies a quality of service condition during transmission.

Detecting whether the service data packet transmitted between the application server and the access network element satisfies the quality of service condition during transmission may be that: detect whether the service data packet transmitted between the application server and the UE satisfies the quality of service condition during transmission, for example, detect whether the end-to-end data transmission satisfies the quality of service condition.

The access network element (for example, the base station) may detect whether the service data packet transmitted between the application server and the access network element satisfies the quality of service condition during transmission. If the quality of service condition is not met, indication information may be sent to the application object. The application object may further actively detect whether the service data packet satisfies the quality of service condition during transmission by collecting a transmission feedback parameter and a network characteristic of the service data packet.

Operation 620: Re-adjust the parameter of the to-be-transmitted service data packet based on the network status information on the radio access network side, the network transmission characteristic between the access network element and the core network gateway, and the network transmission characteristic between the application server and the core network gateway if the service data packet transmitted between the application server and the access network element may not satisfy the quality of service condition during the transmission.

A process of re-adjusting the parameter of the to-be-transmitted service data packet based on the network status information on the radio access network side, the network transmission characteristic between the access network element and the core network gateway, and the network transmission characteristic between the application server and the core network gateway may be repeated for a plurality of times. Until the parameter of the to-be-transmitted service data packet is re-adjusted and the service data packet transmitted between the application server and the access network element satisfies the quality of service condition during transmission.

Operation 630: Perform data transmission based on the re-adjusted parameter of the service data packet.

According to some embodiments shown in FIG. 5 and FIG. 6, the application layer (including the application object and/or the application server) may grasp the network transmission situation with the user equipment. The parameter of the service data packet may be adjusted to ensure that the parameter of the service data packet matches the network transmission situation, which may be conducive to improving the QoS and satisfying the QoS condition.

In some embodiments, the application layer adjusts the parameter of the to-be-transmitted service data packet based on the network status information on the radio access network side, the network transmission characteristic between the access network element and the core network gateway, and the network transmission characteristic between the application server and the core network gateway. In some embodiments, the application layer may adjust the parameter of the to-be-transmitted service data packet by using one or two of the network status information on the radio access network side, the network transmission characteristic between the access network element and the core network gateway, and the network transmission characteristic between the application server and the core network gateway. For example, the parameter of the to-be-transmitted service data packet may be adjusted only based on the network status information on the radio access network side.

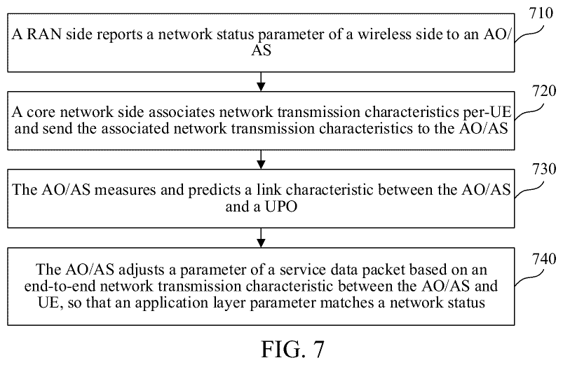

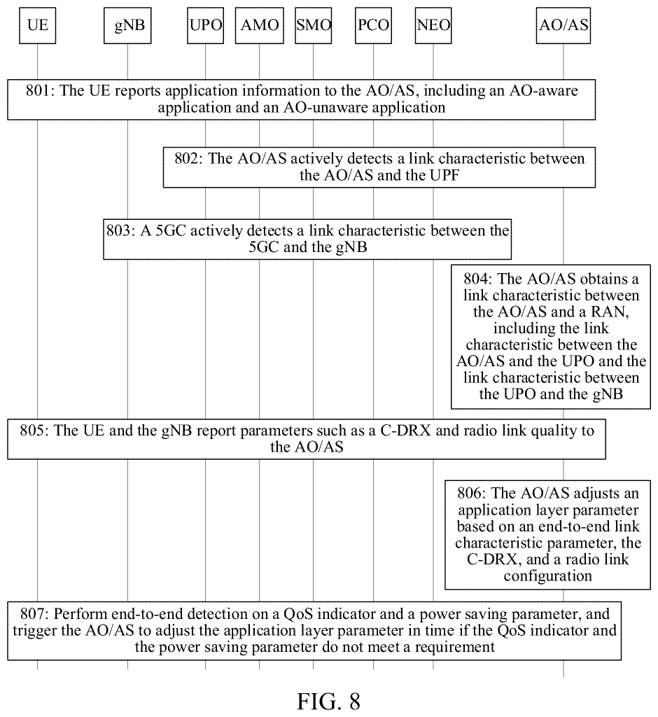

Some embodiments are described below with reference to FIG. 7 to FIG. 8.

FIG. 7 is a flowchart of a data transmission method according to some embodiments. The method may include the following operations.

710: A RAN side reports a network status parameter of a wireless side to an AO/AS.

In some embodiments, a parameter reported on the RAN side include but is not limited to: a C-DRX cyclical configuration parameter; an application layer service condition of UE; and a radio link status, a cell resource congestion state, and the like of the UE in a current cell.

The C-DRX cyclical configuration parameter includes a C-DRX cycle, C-DRX on (for example, On Duration, activation duration) and off (for example, Opportunity for DRX, sleep duration) duration, and the like.

The C-DRX cyclical configuration parameter may have a constraint based on the cycle being set and may not be flexibly adjusted. The application layer may be more flexible in adjusting the granularity of the frame rate, the cycle, and the like. The C-DRX cyclical configuration parameter may be reported to the AO/AS, and based on receiving the C-DRX cyclical configuration parameter, the AO/AS may adapt to the C-DRX cycle by adjusting the frame rate, the cycle, and the like of the application layer. A principle of adaptation is that a cycle of an application layer frame is an integer multiple of the C-DRX cycle.

The application layer service condition of the UE may be whether the application installed on the UE uses AO/AS awareness or may not use AO/AS awareness. If the application uses AO/AS awareness, the application may be aware by the AO/AS (for example, an application server side); or if the application may not use AO/AS awareness, the application may not use the AO/AS (for example, an application server side) to be aware of these applications.

Some applications on the UE use AO/AS awareness, and some may not use AO/AS awareness. Applications that may not use AO/AS awareness may affect the effectiveness of the C-DRX configuration if traffic is generated. For a situation where the AO/AS is to adjust the rate to adapt to the C-DRX, the UE may report all application information to the AO/AS.

Based on the application information of the UE being reported to the AO/AS, the AO/AS may perform rate adjustment and adaptation on a multimedia service data packet such as XR for all application information reported by the UE. The AO/AS may be able to send and receive control over all applications on the UE and may ensure the effectiveness of the C-DRX configuration.

The radio link status of the UE in the current cell may be represented by a parameter such as SINR, RSRP, RSRQ, and RSSI of the serving cell in which the UE is currently located. The information reported by the UE may further include a cell load (for example, a cell load), where the cell load may be measured by all PRBs and a number of the remaining available PRBs.

720: A core network side associates network transmission characteristics per-UE and send the associated network transmission characteristics to the AO/AS.

Based on the service data packet generated by the AS being sent, the service data packet may be transmitted to the access network through UPO-gNB, or the service data packet may be transmitted to the access network through PSA UPO-I-UPO-gNB. An interface between the UPO and the gNB is an N3 interface, and an interface between the UPO and the UPO is an N9 interface. The core network may detect a characteristic of an N3 interface link between the gNB and the UPO and a characteristic of an N9 interface link between UPOs, and combine the characteristics with the per-UE protocol data session and QoS flow established by each UE to analyze and collect statistics on the network transmission characteristic of the N3 interface link the network transmission characteristic of the N9 interface link.

In some embodiments, the network transmission characteristic refers to an impact of network transmission on the cyclicity and the delay jitter distribution characteristic of the service flow generated by the AO/AS. The cyclical service flow generated by the AO/AS may be sent in a burst mode. After reaching the UPO from the AO/AS, whether the cyclical service flow is affected in the UPO-gNB or PSA UPO-I-UPO-gNB transmission process may be determined. A strong N3 interface link or N3+N9 interface link may have less impact on the cyclicity or the delay jitter distribution of the service flow. If the impact on the delay jitter distribution of the service flow is small, the data packet reaching the gNB may be maintained in a relatively concentrated burst mode. A size of these bursts has a direct impact on configuring the on (activation duration) duration of the C-DRX.

730: The AO/AS measures and predicts a link characteristic between the AO/AS and a UPO.

In some embodiments, the AO/AS detects a link between the AO/AS and the UPO to obtain a network transmission characteristic. The network transmission characteristic refers to an impact of network transmission on the cyclicity and the delay jitter distribution characteristic of the service flow generated by the AO/AS. For example, the cyclical service flow generated by the AO/AS is sent in a burst mode, which may be affected based on being transmitted from the AO/AS to the UPO. An AO/AS-UPO transmission link may have less impact on the cyclicity or the delay jitter distribution of the service flow. If the impact on the delay jitter distribution of the service flow is small, the data packet reaching the UPO may be maintained in a relatively concentrated burst mode. Based on the transmission link between the UPO and the gNB being strong, the cyclicity and the burst mode of the service flow may be maintained.

740: The AO/AS adjusts a parameter of a service data packet based on an end-to-end network transmission characteristic between the AO/AS and UE, so that an application layer parameter matches a network status.

Based on the AO/AS measuring and predicting the link characteristic between the AO/AS and the UPO, combined with data sent from the RAN side and the core network side, the end-to-end network transmission characteristic from the AO to the UE may be grasped, and the application layer parameter may be adjusted based on the C-DRX and the radio link configuration, so that adjustment and adaptation of the application layer may be consistent with the network side, which may optimize the QoS.

In some embodiments, an execution order from 710 to 730 shown in FIG. 7 is not limited. In implementation, operations may be executed in the order shown in FIG. 7, or may be executed simultaneously, or the execution order may be arbitrarily changed.

An interactive process of some embodiments shown in FIG. 7 is shown in FIG. 8, including the following operations.

801: UE reports application information to an AO/AS, including an application that is to be sensed by the AO/AS and an application that may not be sensed by the AO/AS.

Because traffic generated by the application that may not use AO/AS awareness may affect the effectiveness of the C-DRX configuration, in a situation where the AO/AS is to adjust the rate to match the C-DRX, the UE may report all application information to the AO/AS. Based on the application information of the UE being reported to the AO/AS, the AO/AS may perform rate adjustment and adaptation on a multimedia service data packet such as XR for all application information reported by the UE. The AO/AS may be able to send and receive control over all applications on the UE and may ensure the effectiveness of the C-DRX configuration.

802: The AO/AS actively detects a link characteristic between the AO/AS and a UPO.

That the AO/AS actively detects a link characteristic between the AO/AS and a UPO may include: dynamically detecting the transmission link between the AO/AS and the UPO, determining a transmission bandwidth and a delay change of the transmission link based on a dynamic detection result of the transmission link, and using the transmission bandwidth and the delay changes as the link characteristic between the AO/AS and the UPO.

803: A 5GC actively detects a link characteristic between the 5GC and a gNB.

The 5GC actively detects the link characteristic between the 5GC and the gNB by detecting the link characteristic between the UPO and the gNB. Based on the service data packet generated by the AS being sent, the service data packet may be transmitted to the access network through UPO-gNB, or the service data packet may be transmitted to the access network through PSA UPO-I-UPO-gNB. An interface between the UPO and the gNB is an N3 interface, and an interface between the UPO and the UPO is an N9 interface. The 5GC network element may detect the characteristic of the N3 interface link between the gNB and the UPO and the characteristic of the N9 interface link between UPOs, and may also combine the characteristics with the per-UE protocol data session and QoS flow established by each UE to analyze and collect statistics on the network transmission characteristic of the N3 interface link the network transmission characteristic of the N9 interface link.

804: The AO/AS obtains a link characteristic between the AO/AS and a RAN, including the link characteristic between the AO/AS and the UPO and the link characteristic between the UPO and the gNB.

805: The UE and the gNB report parameters such as a C-DRX and radio link quality to the AO/AS.

The C-DRX cyclical configuration parameter reported by the gNB includes the C-DRX cycle, on and off duration, and the like.

Parameters such as the radio link quality reported by the UE may be represented by parameters such as SINR, RSRP, RSRQ and RSSI of the serving cell in which the UE is currently located. The information reported by the UE may further include a cell load, where the cell load may be measured by all PRBs and a number of the remaining available PRBs.

806: The AO/AS adjusts an application layer parameter based on an end-to-end link characteristic parameter, the C-DRX, and a radio link configuration.

Based on the AO/AS measuring and predicting the link characteristic between the AO/AS and the UPO, combined with data sent from the RAN side and the core network side, the end-to-end network transmission characteristic from the AO to the UE may be grasped, and the application layer parameter may be adjusted based on the C-DRX and the radio link configuration, so that adjustment and adaptation of the application layer may be consistent with the network side, which may optimize the QoS.

807: Perform end-to-end detection on a QoS indicator and a power saving parameter, and trigger the AO/AS to adjust the application layer parameter in time if the QoS indicator and the power saving parameter may not satisfy a condition.

A process of triggering the AO/AS to adjust the application layer parameter may be repeated for a plurality of times until the end-to-end detection performed on the QoS indicator and the power saving parameter satisfy the condition based on the application side parameter being re-adjusted.

In some embodiments, the RAN side may report the network status parameter of the radio access network side to the AO/AS. The core network side may associate network transmission characteristics per-UE and send the associated network transmission characteristics to the AO/AS. In addition, the AO/AS may measure and predict a link characteristic between the AO/AS and the UPO, so that an end-to-end network transmission characteristic from the AO to the UE is grasped. Parameters that affect the rate such as the frame rate and the resolution of the service data packet may be adjusted to implement flexible adaptation of the service data packet and the network status, which may optimize the QoS.

The following describes an apparatus according to some embodiments, which may be used to implement the data transmission method according to some embodiments.

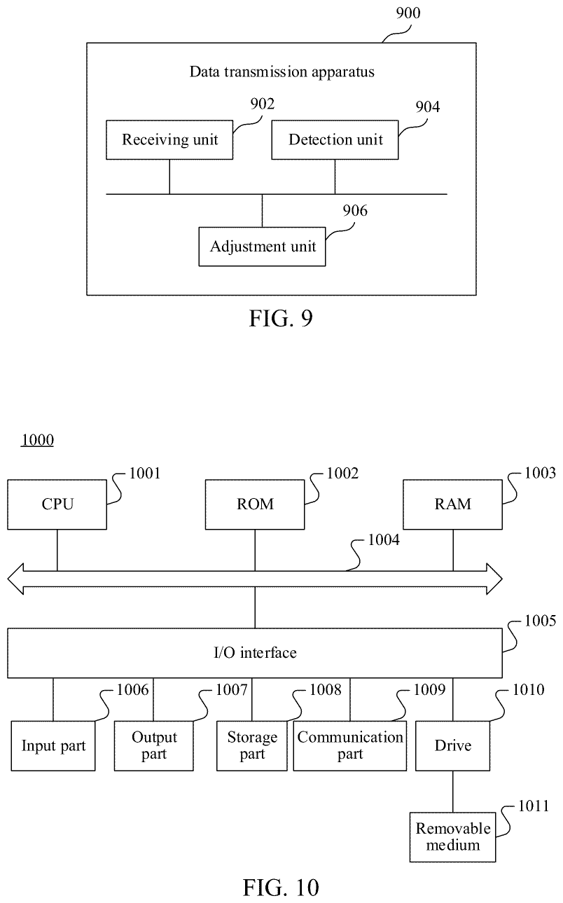

FIG. 9 is a block diagram of a data transmission apparatus according to some embodiments. The data transmission apparatus may be disposed in an application layer network element, for example, may be disposed in an AO.

Referring to FIG. 9, a data transmission apparatus 900 according to some embodiments includes: a receiving unit 902, a detection unit 904, and an adjustment unit 906.

The receiving unit 902 may be configured to receive network status information on a radio access network side reported by an access network element, and receive a network transmission characteristic between the access network element and a core network gateway sent by a core network element. The detection unit 904 may be configured to detect a network transmission characteristic between an application server and the core network gateway. The adjustment unit 906 may be configured to adjust a parameter of a to-be-transmitted service data packet based on the network status information on the radio access network side, the network transmission characteristic between the access network element and the core network gateway 906 the network transmission characteristic between the application server and the core network gateway.

In some embodiments, the network status information on the radio access network side includes at least one of the following: a scheduling transmission policy adopted for a cyclical service data packet, an application layer service condition of user equipment, or a network status in a serving cell in which the user equipment is located.

In some embodiments, the scheduling transmission policy includes a connected-discontinuous reception (C-DRX) configuration parameter, the C-DRX configuration parameter including at least one of the following: a C-DRX cycle, or activation duration and sleep duration included in a single C-DRX cycle.

In some embodiments, the parameter of the to-be-transmitted service data packet includes a cycle of the service data packet; and the adjusting a parameter of a to-be-transmitted service data packet includes: adjusting the cycle of the to-be-transmitted service data packet to an integer multiple of the C-DRX cycle.

In some embodiments, the application layer service condition of the user equipment includes at least one of the following: information about an application running on the user equipment that is to be sensed by an application server, or information about an application running on the user equipment that may not be sensed by the application server.

In some embodiments, the network status in the serving cell in which the user equipment is located includes at least one of the following: a radio link status in the serving cell, occupation of a time-frequency resource in the serving cell, or load information of the serving cell.

In some embodiments, the receiving unit may be configured to: receive a network transmission characteristic between a base station device and a user plane object for each user equipment sent by the core network element, the network transmission characteristic between the base station device and the user plane object for each user equipment being determined by the core network element based on a transmission link between the base station device and the user plane object, based on a transmission link between a plurality of user plane objects for data forwarding, and a protocol data session (or “protocol data unit” (PDU) session) and a quality of service flow established for each user equipment.

In some embodiments, the detection unit may be configured to: dynamically detect a transmission link between the application server and the core network gateway; and determine the network transmission characteristic between the application server and the core network gateway based on a dynamic detection result of the transmission link.

In some embodiments, the network transmission characteristic between the application server and the core network gateway includes: an impact of the transmission link between the application server and the core network gateway on cycle information and a delay jitter distribution characteristic of the transmitted service data packet.

In some embodiments, the parameter of the to-be-transmitted service data packet includes at least one of the following: a frame rate of the service data packet, resolution of the service data packet, or a cycle of the service data packet.

In some embodiments, the detection unit is further configured to: detect, based on the parameter of the to-be-transmitted service data packet being adjusted, whether the service data packet transmitted between the application server and the access network element satisfies a quality of service condition during transmission; and the adjustment unit is further configured to: re-adjust the parameter of the to-be-transmitted service data packet based on the network status information on the radio access network side, the network transmission characteristic between the access network element and the core network gateway, and the network transmission characteristic between the application server and the core network gateway if the service data packet transmitted between the application server and the access network element may not satisfy the quality of service condition during the transmission; and perform data transmission based on the re-adjusted parameter of the service data packet.

According to some embodiments, each object, function, or unit may exist respectively or be combined into one or more units. Some objects, functions, or units may be further split into multiple smaller function subunits, thereby implementing the same operations without affecting the technical effects. The objects, functions, or units are divided based on logical functions. A function of one object, function, or unit may be realized by multiple units, or functions of multiple objects, functions, or units may be realized by one unit. In some embodiments, the apparatus may further include other objects, functions, or units. These functions may also be realized cooperatively by the other objects, functions, or units, and may be realized cooperatively by multiple objects, functions, or units.

A person skilled in the art would understand that these “objects,” “functions,” or “units” could be implemented by hardware logic, a processor or processors executing computer software code, or a combination of both. The “objects,” “functions,” or “units” may also be implemented in software stored in a memory of a computer or a non-transitory computer-readable medium, where the instructions of each unit are executable by a processor to thereby cause the processor to perform the respective operations of the corresponding unit.

FIG. 10 is a schematic structural diagram of a computer system adapted to implement an electronic device according to some embodiments.

The computer system 1000 of the electronic device shown in FIG. 10 is an example, and may not constitute any limitation on functions and use ranges of some embodiments.

As shown in FIG. 10, the computer system 1000 includes a central processing unit (CPU) 1001, which may perform various actions and processing based on a program stored in a read-only memory (ROM) 1002 or a program loaded from a storage part 1008 into a random access memory (RAM) 1003, for example, perform the method described in some embodiments. The RAM 1003 further stores various programs and data used for system operations. The CPU 1001, the ROM 1002, and the RAM 1003 are connected to each other through a bus 1004. An input/output (I/O) interface 1005 is also connected to the bus 1004.

The following components are connected to the I/O interface 1005: an input part 1006 including a keyboard and a mouse, or the like; an output part 1007 including a cathode ray tube (CRT), a liquid crystal display (LCD), a speaker, or the like; a storage part 1008 including hard disk, or the like; and a communication part 1009 including a network interface card such as a local area network (LAN) card, a modem, or the like. The communication part 1009 performs communication processing by using a network such as the Internet. A drive 1010 is also connected to the I/O interface 1005. A removable medium 1011, such as a magnetic disk, an optical disc, a magneto-optical disk, or a semiconductor memory, may be mounted on the driver 1010, so that a computer program read from the removable medium is installed into the storage part 1008.

According to some embodiments, the processes described by referring to the flowcharts may be implemented as computer software programs. For example, some embodiments includes a computer program product. The computer program product includes a computer program stored in a computer-readable medium. The computer program includes a computer program used for performing a method shown in the flowchart. In some embodiments, the computer program may be downloaded and installed through the communication part 1009 from a network, and/or installed from the removable medium 1011. When the computer program is executed by the CPU 1001, the various functions defined in the system are executed.

The computer-readable medium shown in some embodiments may be a computer-readable signal medium or a computer-readable storage medium or any combination of two. The computer-readable storage medium may be, for example, but is not limited to, an electrical, magnetic, optical, electromagnetic, infrared, or semiconductor system, apparatus, or device, or any combination thereof. An example of the computer-readable storage medium may include but is not limited to: An electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. The computer-readable storage medium may be any tangible medium containing or storing a program, and the program may be used by or used in combination with an instruction execution system, an apparatus, or a device. A computer-readable signal medium may include a data signal in a baseband or propagated as a part of a carrier wave, the data signal carrying a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may send, propagate, or transmit a program that is used by or used in combination with an instruction execution system, apparatus, or device. The computer program included in the computer-readable storage medium may be transmitted using a medium, including but not limited to: a wireless medium, a wire medium, or the like, or a combination thereof.

The flowcharts and block diagrams in the accompanying drawings illustrate system architectures, functions, and operations that may be implemented by a system, a method, and a computer program product according to some embodiments. Each box in a flowchart or a block diagram may represent a module, a program segment, or a part of code. The module, the program segment, or the part of code includes one or more executable instructions used for implementing designated logic functions. In some implementations used as substitutes, functions annotated in boxes may occur in a sequence different from that annotated in an accompanying drawing. For example, two boxes shown in succession may be performed in parallel, and the two boxes may be performed in a reverse sequence. This is determined by a related function. Each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer program.

Related units described in some embodiments may be implemented in a software manner, or may be implemented in a hardware manner, and the unit described may also be set in a processor. Names of the units may not constitute a limitation on the units.

A non-transitory computer readable medium is further provided. The computer readable medium may be included in the electronic device described in some embodiments, or may exist alone without being assembled into the electronic device. The computer-readable medium may carry one or more computer programs, the one or more computer programs, when executed by the electronic device, causing the electronic device to implement the method described in some embodiments.

Through the descriptions of the foregoing embodiments, a person of ordinary skill in the art understands that some embodiments may be implemented through software, or may be implemented through software located in combination with hardware. Therefore, the technical solutions of some embodiments may be implemented in a form of a software product. The software product may be stored in a non-volatile storage medium (which may be a CD-ROM, a USB flash drive, a removable hard disk, or the like) or on the network, including several instructions for instructing a computing device (which may be a personal computer, a server, a touch terminal, a network device, or the like) to perform the methods according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in some embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data transmission method, comprising:
receiving network status information on a radio access network side reported by an access network element;
receiving a first network transmission characteristic between the access network element and a core network gateway sent by a core network element;
detecting a second network transmission characteristic between an application server and the core network gateway; and
adjusting a parameter of a first service data packet to be transmitted based on the network status information, the first network transmission characteristic, and the second network transmission characteristic.

2. The data transmission method according to claim 1, wherein the network status information includes at least one of a scheduling transmission policy adopted for a cyclical service data packet, an application layer service condition of user equipment, or a network status in a serving cell in which the user equipment is located.

3. The data transmission method according to claim 2, wherein the scheduling transmission policy includes a connected-discontinuous reception (C-DRX) configuration parameter, and
wherein the C-DRX configuration parameter includes at least one of a C-DRX cycle, or activation duration and sleep duration included in a single C-DRX cycle.

4. The data transmission method according to claim 3, wherein the parameter of the first service data packet includes a cycle of the first service data packet; and
wherein the adjusting the parameter of the first service data packet includes adjusting the cycle of the first service data packet to an integer multiple of the C-DRX cycle.

5. The data transmission method according to claim 2, wherein the application layer service condition includes at least one of first information about a first application running on the user equipment that is to be sensed by the application server, or second information about a second application running on the user equipment that is not to be sensed by the application server.

6. The data transmission method according to claim 2, wherein the network status in the serving cell includes at least one of a radio link status in the serving cell, occupation of a time-frequency resource in the serving cell, or load information of the serving cell.

7. The data transmission method according to claim 1, wherein the receiving the first network transmission characteristic comprises receiving a third network transmission characteristic between a base station device and a user plane object for user equipment sent by the core network element, and
wherein the third network transmission characteristic is based on a first transmission link between the base station device and the user plane object, a second transmission link between a plurality of user plane objects for data forwarding, and a protocol data session and a quality of service flow established for the user equipment.

8. The data transmission method according to claim 1, wherein the detecting the second network transmission characteristic comprises:
dynamically detecting a third transmission link between the application server and the core network gateway; and
determining the second network transmission characteristic based on a dynamic detection result of the third transmission link.

9. The data transmission method according to claim 8, wherein the second network transmission characteristic includes an impact of the third transmission link on cycle information and a delay jitter distribution characteristic of the first service data packet that is transmitted.

10. The data transmission method according to claim 1, wherein the parameter of the first service data packet includes at least one of a frame rate of the first service data packet, a resolution of the first service data packet, or a cycle of the first service data packet.

11. A data transmission apparatus, comprising:
at least one memory configured to store computer program code;
at least one processor configured to read the program code and operate as instructed by the program code, the program code comprising:
first receiving code configured to cause at least one of the at least one processor to receive network status information on a radio access network side reported by an access network element;
second receiving code configured to cause at least one of the at least one processor to receive a first network transmission characteristic between the access network element and a core network gateway sent by a core network element;
detection code configured to cause at least one of the at least one processor to detect a second network transmission characteristic between an application server and the core network gateway; and
adjustment code configured to cause at least one of the at least one processor to adjust a parameter of a first service data packet to be transmitted based on the network status information, the first network transmission characteristic, and the second network transmission characteristic.

12. The data transmission apparatus according to claim 11, wherein the network status information comprises at least one of:
a scheduling transmission policy adopted for a cyclical service data packet;
an application layer service condition of user equipment; or
a network status in a serving cell in which the user equipment is located.

13. The data transmission apparatus according to claim 12, wherein the scheduling transmission policy comprises a connected-discontinuous reception (C-DRX) configuration parameter, and
wherein the C-DRX configuration parameter comprises at least one of:
a C-DRX cycle; or
activation duration and sleep duration of a single C-DRX cycle.

14. The data transmission apparatus according to claim 13, wherein the parameter of the first service data packet comprises a cycle of the first service data packet; and
wherein the adjustment code is configured to cause at least one of the at least one processor to adjust the cycle of the first service data packet to an integer multiple of the C-DRX cycle.

15. The data transmission apparatus according to claim 12, wherein the application layer service condition comprises at least one of:
first information about a first application configured to run on the user equipment that is to be sensed by the application server; or
second information about a second application configured to run on the user equipment that is not to be sensed by the application server.

16. The data transmission apparatus according to claim 12, wherein the network status in the serving cell comprises at least one of:
a radio link status in the serving cell;
occupation of a time-frequency resource in the serving cell; or
load information of the serving cell.

17. The data transmission apparatus according to claim 11, wherein the second receiving code is configured to cause at least one of the at least one processor to receive a third network transmission characteristic between a base station device and a user plane object for user equipment sent by the core network element, and
wherein the third network transmission characteristic is based on a first transmission link between the base station device and the user plane object, a second transmission link between a plurality of user plane objects for data forwarding, and a protocol data session and a quality of service flow established for the user equipment.

18. The data transmission apparatus according to claim 11, wherein the detection code is configured to cause at least one of the at least one processor to:
dynamically detect a third transmission link between the application server and the core network gateway; and
determine the second network transmission characteristic based on a dynamic detection result of the third transmission link.

19. The data transmission apparatus according to claim 18, wherein the second network transmission characteristic comprises:
an impact of the third transmission link on cycle information; and
a delay jitter distribution characteristic of the first service data packet that is transmitted.

20. A non-transitory computer-readable medium, storing computer code which, when executed by at least one processor, causes the at least one processor to at least: receive network status information on a radio access network side reported by an access network element, and
receive a first network transmission characteristic between the access network element and a core network gateway sent by a core network element;
detect a second network transmission characteristic between an application server and the core network gateway; and
adjust a parameter of a first service data packet to be transmitted based on the network status information, the first network transmission characteristic, and the second network transmission characteristic.
